(19) United States
(12) Patent Application Publication
(10) Pub. No.: US 2005/0213764 A1
(43) Pub. Date: Sep. 29, 2005

(54) Radio transmission device, mutual authentication method and mutual authentication program

(75) Inventor: Yoshikazu Kita, Osaka (JP)

Correspondence Address: McDermott Will & Emery LLP, 600 13th Street, N.W., Washington, DC, 20005-3096, US

(73) Assignee: Sanyo Electric Co., Ltd.

(21) Appl. No.: 11/090,033

(22) Filed: Mar. 28, 2005

(30) Foreign Application Priority Data
Mar. 29, 2004 (JP) 2004-096172(P)
Feb. 25, 2005 (JP) 2005-051053(P)

(51) Int. Cl. H04N 7/18

(52) U.S. Cl. 380/270; 725/81; 725/78; 725/31; 340/5.74

(57) ABSTRACT

An infrared emission module is adjacently opposed to an infrared receiving unit. In a control unit, a switching unit forms a transmission path of a radio control signal between a central control unit and an infrared control unit. The central control unit in the control unit provides a radio unit MA address. The radio unit MAC address is transferred to an infrared transmitting unit via the infrared control unit, and is emitted from an infrared emission module. The infrared signal emitted from the infrared emission module is received by the infrared receiving unit. The control unit decrypts the infrared signal, and extracts the radio unit MAC address of the opposite party of transmission to end an authentication mode.

### BACKGROUND OF THE INVENTION

1. Field of the Invention

The present invention relates to a radio transmission device, a mutual authentication method and a mutual authentication program, and more particularly to a radio transmission device performing mutual authentication when performing radio transmission of data signals as well as a mutual authentication method and a mutual authentication program executed by such a radio transmission device.

2. Description of the Background Art

In recent years, large attention has been given to a field of home networks, and technologies for establishing radio home networks have been actively developed. As an example of such technologies, there has been developed a radio transmission device, which couples a home-use electric appliance and a computer by radio in a space of a limited area such as a home or office. For example, there has been developed a radio transmission device, which couples by radio an AV data reproducing device such as a video tape recorder or a DVD (Digital Versatile Disk) player reproducing video and audio signals (which may be collectively referred to as “AV data” hereinafter) to an AV data display device such as a television set or a projector.

FIG. 7 schematically shows an example of a manner of use of a radio transmission device.

Referring to FIG. 7, AV data display devices 40a-40c such as television sets are arranged on respective floors of a home 50. On the first floor, an AV data reproducing device 30 such as a video tape recorder, which is connected to an AV data display device 40a, is arranged on the first floor. AV data reproducing device 30 and AV data display devices 40b and 40c are connected to radio transmission devices 70a, 70c and 70c, respectively.

When the above structure operates in a normal communication mode, the AV data reproduced by AV data reproducing device 30 arranged on the first floor is transmitted via a cable, and is also converted by radio transmission device 70a into radio signals, which are transmitted to radio transmission devices 70b and 70c arranged on the second and third floors, respectively.

Radio transmission devices 70b and 70c receive the radio signals thus transmitted, and convert these signals into the original AV data, and AV data display devices 40b and 40c output the AV data thus converted.

For correctly coupling the AV data signal reproducing device and the AV data display device desired by a user, as shown in FIG. 7, mutual authentication must be performed between radio transmission devices arranged for the respective devices prior to the radio transmission. This is because the radio-transmitted AV data may be received by an indefinite number of radio transmission devices such as a radio transmission device in another home, in contrast to the wire-transmission.

Technologies of the mutual authentication operation have already been developed for use in a technical field of a radio LAN (Local Area Network), which is employed for data transmission and others between terminal devices of personal computers or the like, as disclosed in Japanese Patent Laying-Open Nos. 04-205453, 62-120564 and U.S. Pat. No. 4,471,216.

FIG. 8 illustrates a configuration of a mutual authentication method disclosed in Japanese Patent Laying-Open No. 04-205453.

Referring to FIG. 8, an information carrier 100 such as an IC card device and an information processing device 110 for center control executes mutual authentication for authenticating each other before information communication.

More specifically, information carrier 100 transmits individual data ID, which is prestored in a first storing unit 101, by a first transmitting unit 108 to information processing device 110, i.e., an opposite party of communication. Individual data ID is peculiar to each individual information carrier, and is managed by information processing device 110.

In information processing device 110, a data processing unit 112 produces a master key km peculiar to each information carrier from received individual data ID and a center key stored in a third storing unit 111. Thus, one master key km is produced corresponding to one individual data ID. A second storing unit 102 of information carrier 100 prestores this master key km.

Information processing device 110 further produces a session key ks by a key producing unit 116 in a random fashion. A second encrypting unit 113 encrypts session key ks with master key km provided from data processing unit 112. A second transmitting unit 118 transmits encrypted data Ekm[ks] to information carrier 100.

Information carrier 100 receives encrypted data Ekm[ks], and decrypts it by first decrypting unit 103 with master key km stored in second storing unit 102.

Further, session key ks, which is the data obtained by decryption, is transferred to a first encrypting unit 105. First encrypting unit 105 encrypts coupling data provided from a coupling unit 104 with session key ks. First transmitting unit 108 transmits coupled data Eks[R∥ID] thus encrypted to information processing device 110. Coupled data Eks[R∥ID] is formed by sequential coupling of individual data ID stored in first storing unit 101 and a random number R produced by a random number producing unit 106.

Information processing device 110 decrypts coupled data Eks[R∥ID] by a second decrypting unit 115 with session key ks. From encrypted data R∥ID, a separating unit 114 produces a random number R′ and individual data ID′ separated from each other.

A second comparing unit 117 compares individual data ID′ with initially received individual data ID for checking information carrier 100. When mismatching occurs between these data, it is assumed that a certain fraud occurred, and information carrier 100 is rejected.

In information carrier 100, a first comparing unit 107 compares received random number R′ with random number R produced by random number producing unit 106 to check information processing device 110. When mismatching occurs between these numbers, it is assumed that a certain fraud occurred, and information processing device 110 is rejected.

Only after the opposite parties are mutually authenticated by the foregoing operations, information communication can be performed between them. The subsequent communication is performed with session key ks.

In a conventional mutual authentication method, an information processing device produces a master key and a session key, and individual data, which is encrypted with these keys, is transmitted between information carriers so that high security can be ensured.

However, each device must perform complicated and sophisticated processing in a complicated encryption method, and this makes it difficult to apply the conventional method to radio home networks, which can be expected to come rapidly into widespread use.

For increasing general versatility of the radio transmission devices, therefore, it is necessary to provide a simple mutual authentication method ensuring high security.

### SUMMARY OF THE INVENTION

An object of the invention is to provide a radio transmission device, a mutual authentication method and a mutual authentication program) which can perform mutual authentication with high concealability by a simple structure.

According to an aspect of the invention, a radio transmission device for transmitting a data signal by radio, includes a mutual authentication unit for performing mutual authentication of opposite parties between the radio transmission devices performing radio transmission, and a radio transmitting unit for transmitting the data signal by radio between the authenticated radio transmission devices. The radio transmitting unit includes a control unit for controlling the whole radio transmission device, a radio unit for sending and receiving the data signal and a first control signal to be transmitted to and from the control unit after converting the data signal and the fist control signal to radio signals, an infrared signal receiving unit for receiving an infrared signal, converting the received infrared signal to an electric signal, extracting a second control signal from the electric signal, and transmitting the extracted second control signal to the control unit, and an infrared signal transmitting unit for converting the second control signal transmitted from the control unit to an infrared signal, and transmitting the converted infrared signal. The mutual authentication unit includes a signal path switching unit for switching a transmission path to transmit the first control signal from the control unit to the infrared signal transmitting unit, an identification information transmitting unit for transmitting identification information provided as the first control signal from the control unit and being peculiar to the radio transmission device via the signal path switching unit to the infrared signal transmitting unit, an identification information sending unit for converting the transmitted identification information peculiar to the radio transmission device to the infrared signal, and emitting the converted infrared signal toward the infrared signal receiving unit of the radio transmission device of the opposite party of the transmission opposed to the infrared signal transmitting unit, an identification information receiving unit for receiving, by the infrared signal receiving unit, the infrared signal emitted from the infrared signal transmitting unit of the radio transmission device of the opposite party of the transmission, and an authentication unit for transmitting the received infrared signal to the control unit, and obtaining the identification information peculiar to the radio transmission device of the opposite party of the transmission from the infrared signal.

Preferably, the infrared signal transmitting unit includes an infrared emitting element emitting the infrared signal to a limited irradiation range. The identification information sending unit emits the infrared signal to the infrared signal receiving unit of the radio transmission device of the opposite party of the transmission located in the irradiation range of the infrared emitting unit and opposed to the infrared emitting unit.

According to another aspect of the invention, the invention provides a mutual authentication method of performing mutual authentication of opposite parties between first and second radio transmission devices performing radio transmission. Each of the first and second radio transmission devices includes a control unit for controlling the whole radio transmission device, a radio unit for sending and receiving the data signal and a first control signal to be transmitted to and from the control unit after converting the data signal and the fist control signal to radio signals, an infrared signal receiving unit for receiving an infrared signal emitted from a remote control, converting the received infrared signal to an electric signal, extracting a second control signal from the electric signal, and transmitting the extracted second control signal to the control unit, an infrared signal transmitting unit for converting the second control signal transmitted from the control unit to an infrared signal, and transmitting the converted infrared signal, and a signal path switching unit arranged between the control unit on one side, and the radio unit and the infrared signal transmitting unit on the other side for switching a transmission path of the first control signal. The mutual authentication method includes the steps of arranging the first and second radio transmission devices such that the infrared signal receiving unit of one of the first and second radio transmission devices is adjacently opposed to the infrared signal transmitting unit of the other; forming, in each of the first and second radio transmission devices, a transmission path of the first control signal between the control unit and the infrared signal transmitting unit by the signal path switching unit; operating the first radio transmission device to transmit identification information provided as the first control signal by the control unit and being peculiar to the first radio transmission device to the infrared signal transmitting unit; causing the first radio transmission device to convert the transmitted identification information peculiar to the first radio transmission device to a first infrared signal, and to emit the first infrared signal toward the infrared signal receiving unit of the second radio transmission device from the infrared signal transmitting unit; causing the second radio transmission device to transmit the identification information provided as the first control signal by the control unit and being peculiar to the second radio transmission device to the infrared signal transmitting unit; causing the second radio transmission device to convert the transmitted identification information peculiar to the second radio transmission device to a second infrared signal, and emitting the second infrared signal from the infrared signal transmitting unit to the infrared signal receiving unit of the first radio transmission device; causing the first radio transmission device to receive the second infrared signal by the infrared signal receiving unit; obtaining the identification information peculiar to the second radio transmission device from the second infrared signal by the control unit of the first radio transmission device; receiving the first infrared signal by the infrared signal receiving unit of the second radio transmission device; and obtaining the identification information peculiar to the first radio transmission device from the first infrared signal by the control unit of the second radio transmission device.

Preferably, the step of arranging the first and second radio transmission devices such that the infrared signal receiving unit of one of the first and second radio transmission devices is adjacently opposed to the infrared signal transmitting unit of the other includes a step of arranging the infrared signal receiving unit of one of the first and second radio transmission devices in the opposed fashion within an irradiation range of an infrared emitting unit included in the infrared signal receiving unit of the other.

According to still another aspect of the invention, the invention provides a mutual authentication program of performing mutual authentication of opposite parties between first and second radio transmission devices performing radio transmission. Each of the first and second radio transmission devices includes a control unit for controlling the whole radio transmission device, a radio unit for sending and receiving the data signal and a first control signal to be transmitted to and from the control unit after converting the data signal and the fist control signal to radio signals, an infrared signal receiving unit for receiving an infrared signal emitted from a remote control, converting the received infrared signal to an electric signal, extracting a second control signal from the electric signal, and transmitting the extracted second control signal to the control unit, an infrared signal transmitting unit for converting the second control signal transmitted from the control unit to an infrared signal, and transmitting the converted infrared signal, and a signal path switching unit arranged between the control unit on one side, and the radio unit and the infrared signal transmitting unit on the other side for switching a transmission path of the first control signal. The mutual authentication program causes a computer to execute the steps of arranging the first and second radio transmission devices such that the infrared signal receiving unit of one of the first and second radio transmission devices is adjacently opposed to the infrared signal transmitting unit of the other; forming, in each of the first and second radio transmission devices, a transmission path of the first control signal between the control unit and the infrared signal transmitting unit by the signal path switching unit; causing the first radio transmission device to transmit identification information provided as the first control signal by the control unit and being peculiar to the first radio transmission device to the infrared signal transmitting unit; causing the first radio transmission device to convert the transmitted identification information peculiar to the first radio transmission device to a first infrared signal, and to emit the first infrared signal toward the infrared signal receiving unit of the second radio transmission device from the infrared signal transmitting unit; causing the second radio transmission device to transmit the identification information provided as the first control signal by the control unit and being peculiar to the second radio transmission device to the infrared signal transmitting unit; causing the second radio transmission device to convert the transmitted identification information peculiar to the second radio transmission device to a second infrared signal, and emitting the second infrared signal from the infrared signal transmitting unit to the infrared signal receiving unit of the first radio transmission device, causing the first radio transmission device to receive the second infrared signal by the infrared signal receiving unit; obtaining the identification information peculiar to the second radio transmission device from the second infrared signal by the control unit of the first radio transmission device; receiving the first infrared signal by the infrared signal receiving unit of the second radio transmission device; and obtaining the identification information peculiar to the first radio transmission device from the first infrared signal by the control unit of the second radio transmission device.

Preferably, the step of arranging the first and second radio transmission devices such that the infrared signal receiving unit of one of the first and second radio transmission devices is adjacently opposed to the infrared signal transmitting unit of the other includes a step of arranging the infrared signal receiving unit of one of the first and second radio transmission devices in the opposed fashion within an irradiation range of an infrared emitting unit included in the infrared signal receiving unit of the other.

According to the invention, it is possible to prevent misidentification and electrical interference due to another home or office in the mutual authentication operation by a simple structure, and high security can be ensured in the radio transmission system.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram illustrating a whole structure of a radio transmission device according to an embodiment of the invention.

FIG. 2 is a functional block diagram illustrating a specific structure of a control unit in FIG. 1.

FIGS. 3A and 3B schematically illustrate a switching operation of a switching unit in FIG. 2.

FIG. 4 schematically illustrates radio transmission of AV data performed between two radio transmission devices.

FIG. 5 schematically illustrates a principle of a mutual authentication method in the radio transmission device illustrated in FIG. 1.

FIG. 6 illustrates a mutual authentication sequence executed between devices A and B in FIG. 5.

FIG. 7 schematically shows an example of a manner of use of a radio transmission device.

FIG. 8 illustrates a configuration of a mutual authentication method disclosed in Japanese Patent Laying-Open No. 04-205453.

### DESCRIPTION OF THE PREFERRED EMBODIMENTS

Embodiments of the invention will now be described with reference to the drawings. In the following description, the same or corresponding portions bear the same reference numbers.

FIG. 1 is a functional block diagram illustrating a whole structure of a radio transmission device according to an embodiment of the invention.

Referring to FIG. 1, a radio transmission device 10 includes an AV input/output unit 1 for input/output of AV data, a codec unit 2 encoding or decoding the AV data, a combination of a radio unit 3 and an antenna 4 for transmitting and receiving a radio signal to and from a radio transmission device (not shown) of an opposite side or party of the radio transmission, a memory 5 storing various programs and a control unit 6 controlling the whole device.

Radio transmission device 10 further includes an infrared receiving unit 7 receiving an infrared signal, which is emitted from a remote control operated by a user (not shown), and converting the received infrared signal to an electric signal, and an infrared transmitting unit 8 converting the electric signal, which is control information transferred from control unit 6, to an infrared signal. Infrared transmitting unit 8 is connected to an infrared emission module 20 for transmitting the infrared signal.

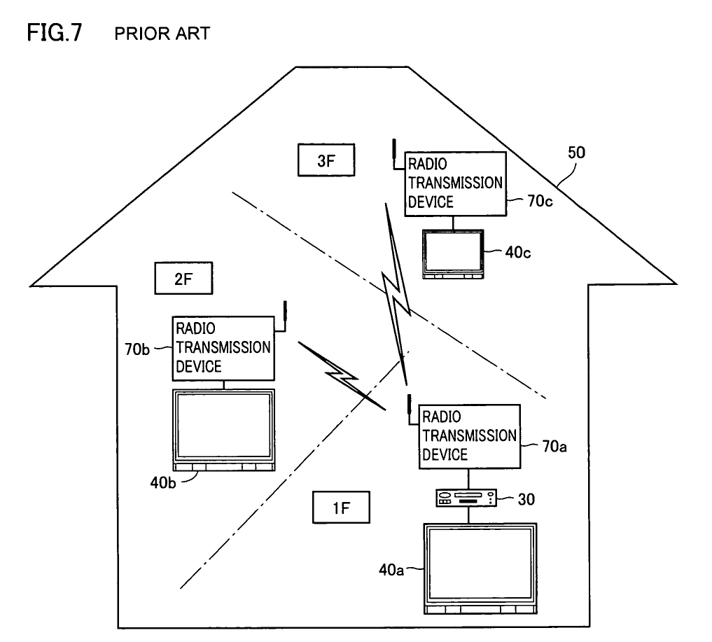

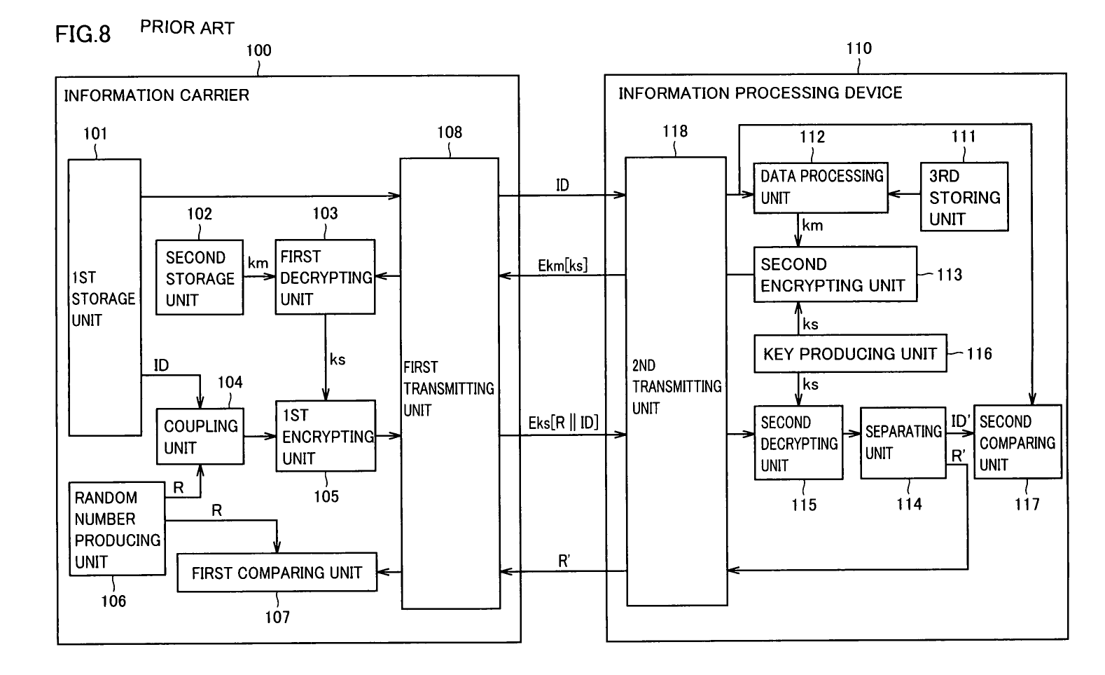

AV input/output unit 1 includes an AV data signal output terminal and an AV data signal input terminal, although not shown. In a manner of use, e.g., shown in FIG. 7, radio transmission device 10 is connected to each of AV data display devices 40b and 40c. In the case, the AV data signal output terminal (not shown) is connected to the AV data input terminal (not shown) of AV data display device 40b or 40c. Thereby, AV input/output unit 1 of radio transmission device 10 transfers the AV data, which is received from AV data reproducing device 30 via radio transmission devices 70a and 70b or radio transmission device 70a and 70c, to corresponding AV data display device 40b or 40c.

When radio transmission device 10 is connected to AV data reproducing device 30 in FIG. 7, the AV data signal input terminal (not shown) is coupled to the AV data signal output terminal (not shown) of AV data reproducing device 30. Thereby, AV input/output unit 1 of radio transmission device 10 receives the AV data reproduced by AV data reproducing device 30.

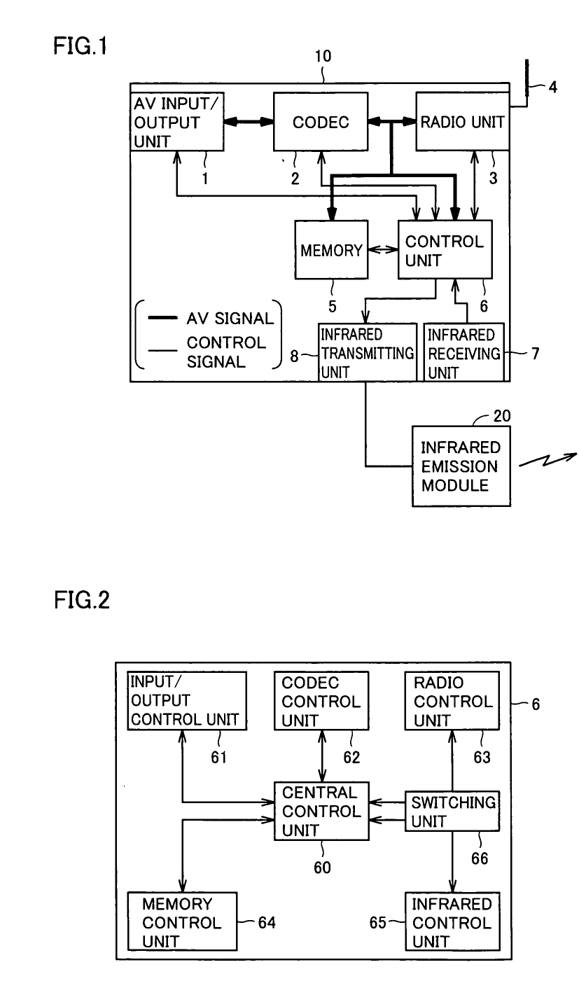

FIG. 2 is a functional block diagram illustrating a specific structure of control unit 6 in FIG. 1.

Referring to FIG. 2, control unit 6 includes units or portions, which control various circuit units in radio transmission device 10, and more specifically includes an input/output control unit 61, a codec control unit 62, a radio control unit 63, a memory control unit 64 and an infrared control unit 65.

Input/output control unit 61, codec control unit 62 and radio control unit 63 control AV input/output unit 1, codec unit 2 and radio unit 3, respectively. Memory control unit 64 controls memory 5. Infrared control unit 65 controls infrared receiving unit 7 and infrared transmitting unit 8.

For overall control of these control units, control unit 6 further includes a central control unit 60. Central control unit 60 transmits and receives control signals to and from control units 61-65. Each of control units 61-65 instructs a circuit unit, which corresponds to the control signal transmitted from central control unit 60, to execute an operation corresponding to contents of the control.

As illustrated in FIG. 2, a switching unit 66 is interposed between central control unit 60 on one side, and radio control unit 63 and infrared control unit 65 on the other side.

Switching unit 66 switches the coupling state of central control unit 60 with respect to radio control unit 63 and infrared control unit 65. Switching unit 66 switches the coupling state in accordance with a normal operation performing the radio transmission and an authentication mode for performing mutual authentication.

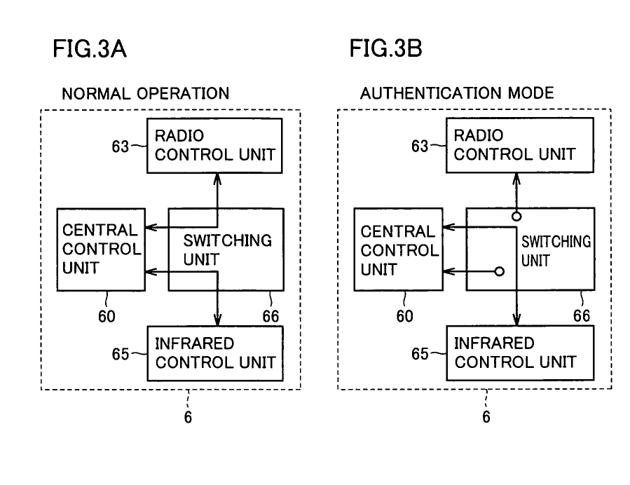

FIGS. 3A and 3B schematically illustrate the switching operation of switching unit 66 in FIG. 2.

In the normal operation, as shown in FIG. 3A, switching unit 66 couples central control unit 60 to radio control unit 63 in a one-to-one relationship, and also couples central control unit 60 to infrared control unit 65 in a one-to-one relationship.

Thereby, central control unit 60 and radio control unit 63 transmit and receive a radio unit control signal, i.e., a signal controlling radio unit 3. Likewise, central control unit 60 and infrared control unit 65 transmit and receive an infrared control signal, i.e., a signal controlling infrared receiving unit 7 and infrared transmitting unit 8.

In the authentication mode illustrated in FIG. 3B, switching unit 66 releases the foregoing coupling in the one-to-one relationship, and switches the coupling state from the coupling between central control unit 60 and radio control unit 63 to the coupling between central control unit 60 and infrared control unit 65. Thereby, the radio control signal, which was to be transmitted from central control unit 60 to radio control unit 63, is transferred to infrared control unit 65. In the authentication mode, therefore, infrared receiving unit 7 and infrared transmitting unit 8 receive the radio control signals via infrared control unit 65.

The above structure is employed for the following reason. As already described in connection with the prior art in FIG. 8, the mutual authentication is achieved by such an operation that each of the devices on the opposite sides performing the radio transmission transmits identification information peculiar to the device itself to the other device after converting it to the radio signal, and authenticates the opposite party from the received identification information. In this operation, the radio signal may be propagated to an unintended space, and may be received by an indefinite number of devices so that misidentification and electrical interference may occur due to another device. Accordingly, it is intended to ensure the security by transmitting the identification information encrypted with keys, which are known only by the devices of the opposite parties of transmission.

Radio transmission device 10 uses an infrared signal for a remote control operation by the remote control. This infrared signal is produced by emitting infrared rays from an LED (Light Emitting Diode) in infrared emission module 20. This LED has a certain directivity, and thus an irradiation range thereof is narrow. Accordingly, the infrared signal is received only in an extremely limited space near it.

According to this embodiment, therefore, the authentication operation is performed in such a manner that transmission of the identification information requiring concealability is performed with the infrared signal of a narrow irradiation range, and is received only by a desired radio transmission device arranged in the limited reception range.

According to the above manner, high security can be simply ensured without requiring complicated encryption processing, which is required in the conventional mutual authentication.

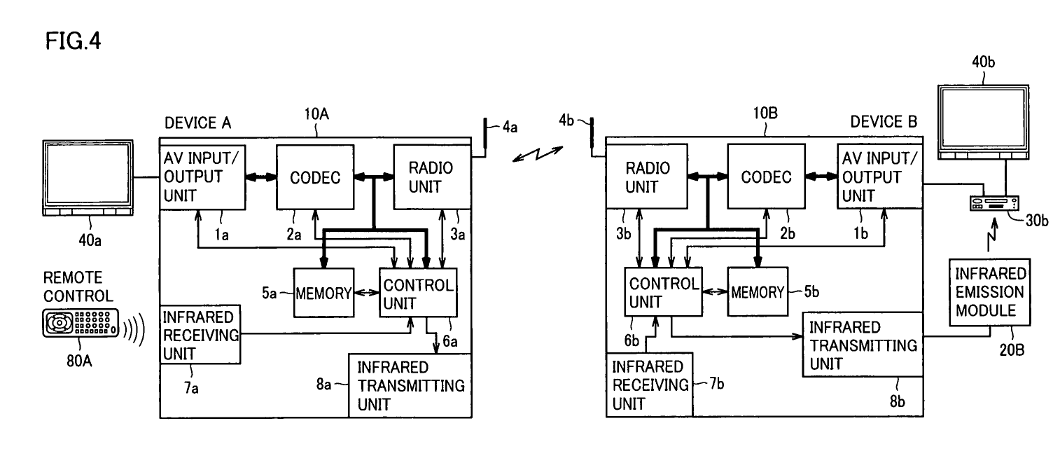

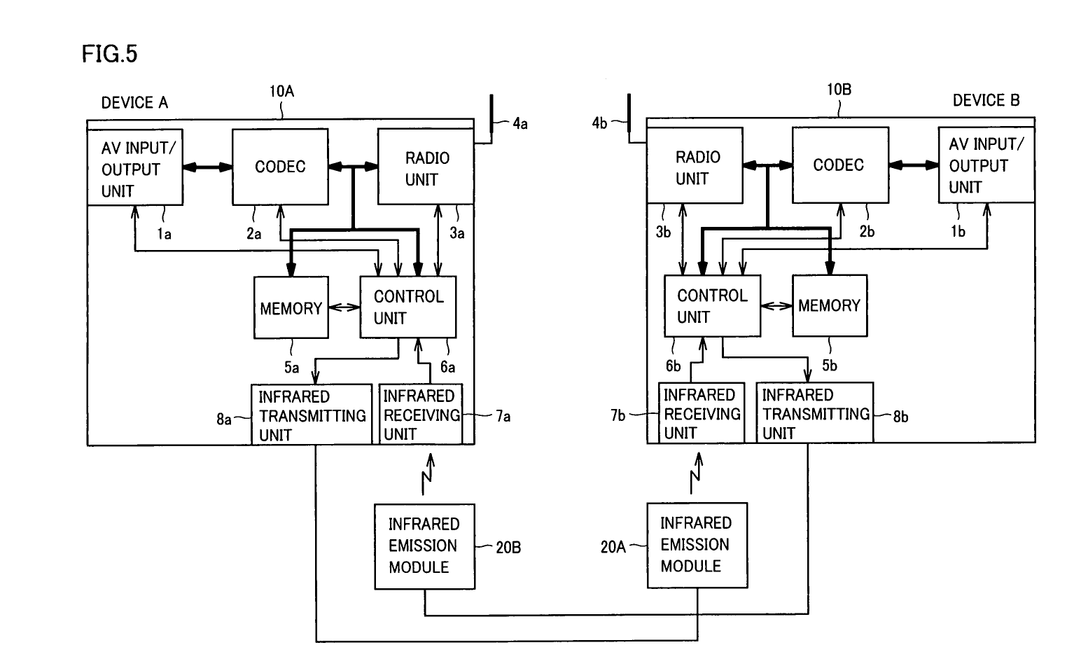

Description will now be given on the radio transmission of the AV data, which is performed in the normal operation by radio transmission device 10 shown in FIG. 1. FIG. 4 schematically illustrates the radio transmission of the AV data between two radio transmission devices (e.g., 10A and 10B).

Referring to FIG. 4, radio transmission device 10A has an AV input/output unit 1a connected to AV data display device 40a. Radio transmission device 10B has an AV input/output unit 1b connected to AV data reproducing device 30b. In the following description, two radio transmission devices 10A and 10B performing the radio transmission may also be referred to as “device A” and “device B”, respectively.

A user, who intends to watch the AV data on desired AV data display device 40a, operates a remote control 80A to emit an infrared signal, which serves as a control signal instructing reproduction of the AV data, to radio transmission device 10A connected to AV data display device 40a. Infrared receiving unit 7a of radio transmission device 10A receives this infrared signal, and converts it to an electric signal.

The electric signal is further transferred to control unit 6a. In control unit 6a, central control unit 60 extracts the control information from the electric signal through infrared control unit 65, and produces a radio control signal corresponding to the extracted control information. When radio control signal is transmitted to a radio unit 3a via radio control unit 63, it is converted to a radio signal, and is transmitted from an antenna 4a. The radio signal is received by an antenna 4b of radio transmission device 10B connected to AV data reproducing device 30b.

Then, radio transmission device 10B connected to AV data reproducing device 30b converts the received radio signal to a radio control signal by a radio unit 3b, and transfers it to control unit 6b. In control unit 6b, central control unit 60 extracts the control information from the radio signal transferred from radio control unit 63, and produces an infrared control signal corresponding to the extracted information. The infrared control signal is transferred to an infrared transmitting unit 8b via infrared control unit 65.

Infrared transmitting unit 8b produces an infrared signal based on the infrared control signal, and emits it from an infrared emission module 20B. An infrared receiving unit (not shown) of AV data reproducing device 30b receives the infrared signal emitted from infrared emission module 20B. AV data reproducing device 30b recognizes the control information included in the infrared signal, and performs the operation instructed by the user.

AV data reproducing device 30b transmits the reproduced AV data to radio transmission device 10B connected thereto. Radio transmission device 10B receives the AV data by AV input/output unit 1b, and encodes it by a codec unit 2b. Radio unit 3b converts the AV data thus encoded to a radio signal, and transmits it via antenna 4b.

Finally, the radio signal is received by antenna 4a of radio transmission device 10A connected to AV data display device 40a, and is converted into the original AV data by a codec unit 2a. The converted AV data is transferred from AV input/output unit 1a to AV data display device 40a. AV data display device 40a displays images according to the image signal of the AV data, and also plays a sound according to the sound signal of the AV data.

As described above, since the radio transmission of the AV data and the infrared signal, i.e., the control signal is performed between the plurality of radio transmission devices, the user can remotely operate the AV data reproducing device to watch and listen to the movie and sound on the desired AV data display device.

For accurately performing the above operations without misidentification and electrical interference, the mutual authentication for mutually authenticating the opposite parties must be performed between the radio transmission devices executing the radio transmission as already described. Description will now be given on the mutual authentication method implemented between the radio transmission devices according to the embodiment. The authentication mode for the mutual authentication precedes the start of the radio transmission, and is executed, e.g., during initial setting performed at the time of connection between radio transmission devices 10.

FIG. 5 schematically illustrates a principle of the mutual authentication method in the radio transmission devices illustrated in FIG. 1.

In the authentication mode, radio transmission devices 10A and 10B (devices A and B) are arranged close to each other as shown in FIG. 5. In this arrangement, it is important that an infrared emission module 20A (or 20B) connected to radio transmission device 10A (or 10B) is opposed to an infrared receiving unit 7b (or 7a) of the other radio transmission device 10B (or 10A).

More specifically, infrared emission module 20A connected to device A is opposed to infrared receiving unit 7b of device B. Infrared emission module 20B connected to device B is opposed to infrared receiving unit 7a of device A. In this arrangement, it is desired that infrared emission modules 20A and 20B are located as close as possible so that the infrared signal emitted from each of infrared emission modules 20A and 20B may not be received by units other than opposed infrared receiving unit 7b or 7a.

In the above arrangement structure, each of control units 6a and 6b of devices A and B operates such that switching unit 66 forms the transmission path of the radio control signal between central control unit 60 and infrared control unit 65, as illustrated in FIGS. 3A and 3B.

When the above structure enters the authentication mode, central control unit 60 in each of control units 6a and 6b of devices A and B provides a radio unit MAC (Media Access Control) address, which is identification information peculiar to radio transmission device 10, as the radio control signal.

At this time, the transmission paths of the radio control signals are already switched in control units 6a and 6b as already described so that each radio unit MAC address is transferred not to radio control unit 63 but to infrared control unit 65. Thereby, the radio unit MAC address is transferred to an infrared transmitting unit 8a or 8b via infrared control unit 65, and is converted into the infrared signal, and infrared emission module 20A or 20B emits the infrared signal thus converted.

The infrared signal emitted from infrared emission module 20A is received by infrared receiving unit 7b of device B opposed thereto. Likewise, the infrared signal emitted from infrared emission module 20B is received by infrared receiving unit 7a of device A opposed thereto. In this state, both the devices are adjacent to each other so that only opposed infrared receiving units 7a and 7b receive the infrared signals.

In device A, infrared receiving unit 7a converts the received infrared signal to the electric signal, and transfers it to control unit 6a. Control unit 6a transfers the electric signal as the radio control signal to central control unit 60a (not show) via the switched transmission path. Central control unit 60a decrypts the electric signal to extract the radio unit MAC address. Since the radio unit MAC address thus extracted is the identification information peculiar to device B, device A authenticates device B as the opposite party of transmission, and stores the radio unit MAC address of device B in memory 5a.

In device B, infrared receiving unit 7b likewise converts the received infrared signal to the electric signal, and transfers it to control unit 6b. Control unit 6b transfers the electric signal as the radio control signal to central control unit 60b (not show). Central control unit 60b decrypts the electric signal to extract the radio unit MAC address. Since the radio unit MAC address thus extracted is the identification information peculiar to device A, device B authenticates device A as the opposite party of transmission, and stores the radio unit MAC address of device A in memory 5b.

When the mutual authentication is completed through the above operations, devices A and B end the authentication mode, and perform the normal operation. In the normal operation, the transmission paths in control units 6a and 6b are restored to the normal state illustrated in FIG. 3A so that control units 6a and 6b designate the obtained radio unit MAC address as the destinations, and transmit the AV data from radio units 3a and 3b, respectively.

The mutual authentication between devices A and B illustrated in FIG. 5 is practically executed by software running on CPUs (Central Processing Units), which form control units 6a and 6b of devices A and B, respectively. The CPUs read programs, which include the steps of the authentication mode already described, from memories 5a and 5b, and execute the read programs to perform the mutual authentication.

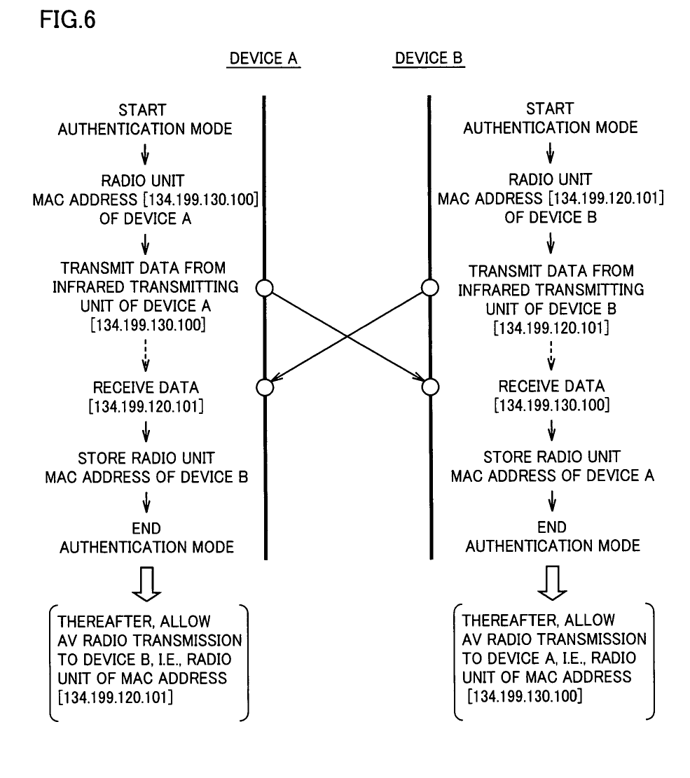

FIG. 6 illustrates a mutual authentication sequence executed between devices A and B in FIG. 5.

Referring to FIG. 6, device A is assigned a radio unit MAC address, e.g., of [134.199.130.100] peculiar to it. Likewise, device B is assigned a radio unit MAC address, e.g., of [134.199.120.101] peculiar to it.

Prior to the start of the authentication mode, infrared emission module 20A of device A is opposed to infrared receiving unit 7b of device B. At the same time, infrared emission module 20B of device B is opposed to infrared receiving unit 7a of device A.

In control units 6a and 6b of devices A and B, switching units 66A and 66b switch the transmission paths of the radio control signals to connect radio control units 63a and 63b to infrared control units 65a and 65b, respectively.

In response to the completion of the above setting, the authentication mode starts. First, device A transmits its own radio unit MAC address [134.199.130.100] to infrared transmission unit 8a via infrared control unit 65a, and emits it as the infrared signal from infrared emission module 20A. After emitting the infrared signal, device A enters a state for waiting for signal reception.

Device B transmits its own radio unit MAC address [134.199.120.101] to infrared transmission unit 8b via infrared control unit 65b, and emits it as the infrared signal from infrared emission module 20B. After emitting the infrared signal, device B likewise enters a state for waiting for signal reception.

When device A receives the infrared signal emitted from infrared module 20B by infrared receiving unit 7a, it converts the received infrared signal to the electric signal, and extracts radio unit MAC address [134.199.120.101] of device B. Device A authenticates device B as the opposite party of transmission, and ends the authentication mode after storing the extracted radio unit MAC address of device B.

When device B receives the infrared signal emitted from infrared module 20A by infrared receiving unit 7b, it converts the received infrared signal to the electric signal, and extracts radio unit MAC address [134.199.130.100] of device A. Device B authenticates device A as the opposite party of transmission, and ends the authentication mode after storing the extracted radio unit MAC address of device A.

In the subsequent normal operation, devices A and B execute the radio transmission using the stored radio unit MAC addresses as the destinations.

In the present invention, the radio control signal forms the “first control signal”, and the infrared control signal forms the “second control signal”.

It is apparent that the radio transmission device according to the invention can be applied to radio transmission other than the radio transmission of the AV data already described, and can be applied to radio transmission of data signals such as programs. In the latter case, the radio transmission device includes a device control unit for controlling a home electric appliance or a computer connected to the radio transmission device, instead of AV input/output unit 1 and codec unit 2 shown in FIG. 1.

According to the embodiment of the invention, as described above, since the authentication operation is performed with the infrared signal, it is possible to avoid the misidentification and electrical interference due to another home or office, which may occur in the authentication operation using radio signals, so that high security can be ensured in the radio transmission system.

Further, the mutual authentication can be performed only by switching the control signal paths in the devices, and by setting the arrangement of the infrared emission modules so that the mutual authentication method can be simple.

Since the radio transmission device according to the invention can ensure high concealability in the radio transmission of data signals, it is possible to spread further the use of radio home networks having high reliability.

Although the present invention has been described and illustrated in detail, it is clearly understood that the same is by way of illustration and example only and is not to be taken by way of limitation, the spirit and scope of the present invention being limited only by the terms of the appended claims.

1. A radio transmission device for transmitting a data signal by radio, comprising:
mutual authentication means for performing mutual authentication of opposite parties between the radio transmission devices performing radio transmission; and
radio transmitting means for transmitting the data signal by radio between said authenticated radio transmission devices, wherein
said radio transmitting means includes:
control means for controlling said whole radio transmission device,
radio means for sending and receiving said data signal and a first control signal to be transmitted to and from the control means after converting the data signal and the fist control signal to radio signals,
infrared signal receiving means for receiving an infrared signal, converting the received infrared signal to an electric signal, extracting a second control signal from said electric signal, and transmitting said extracted second control signal to said control means, and
infrared signal transmitting means for converting said second control signal transmitted from said control means to an infrared signal, and transmitting the converted infrared signal; and
said mutual authentication means includes:
signal path switching means for switching a transmission path to transmit said first control signal from said control means to said infrared signal transmitting means,
identification information transmitting means for transmitting identification information provided as said first control signal from said control means and being peculiar to said radio transmission device via said signal path switching means to said infrared signal transmitting means,
identification information sending means for converting the transmitted identification information peculiar to said radio transmission device to said infrared signal, and emitting the converted infrared signal toward said infrared signal receiving means of the radio transmission device of said opposite party of the transmission opposed to said infrared signal transmitting means,
identification information receiving means for receiving, by said infrared signal receiving means, said infrared signal emitted from said infrared signal transmitting means of the radio transmission device of said opposite party of the transmission, and
authentication means for transmitting said received infrared signal to said control means, and obtaining the identification information peculiar to the radio transmission device of said opposite party of the transmission from said infrared signal.

2. The radio transmission device according to claim 1, wherein said infrared signal transmitting means includes an infrared emitting element emitting said infrared signal to a limited irradiation range, and
said identification information sending means emits the infrared signal to said infrared signal receiving means of the radio transmission device of said opposite party of the transmission located in said irradiation range of said infrared emitting unit and opposed to said infrared emitting unit.

3. A mutual authentication method of performing mutual authentication of opposite parties between first and second radio transmission devices performing radio transmission, each of said first and second radio transmission devices including:
control means for controlling said whole radio transmission device,
radio means for sending and receiving said data signal and a first control signal to be transmitted to and from the control means after converting the data signal and the fist control signal to radio signals,
infrared signal receiving means for receiving an infrared signal emitted from a remote control, converting the received infrared signal to an electric signal, extracting a second control signal from said electric signal, and transmitting said extracted second control signal to said control means,
infrared signal transmitting means for converting said second control signal transmitted from said control means to an infrared signal, and transmitting the converted infrared signal; and
signal path switching means arranged between said control means on one side, and said radio means and said infrared signal transmitting means on the other side for switching a transmission path of said first control signal, and
said method comprising the steps of:
arranging the first and second radio transmission devices such that said infrared signal receiving means of one of said first and second radio transmission devices is adjacently opposed to said infrared signal transmitting means of the other;
forming, in each of said first and second radio transmission devices, a transmission path of said first control signal between said control means and said infrared signal transmitting means by said signal path switching means;
causing said first radio transmission device to transmit identification information provided as said first control signal by said control means and being peculiar to said first radio transmission device to said infrared signal transmitting means;
causing said first radio transmission device to convert the transmitted identification information peculiar to said first radio transmission device to a first infrared signal, and to emit said first infrared signal toward said infrared signal receiving means of said second radio transmission device from said infrared signal transmitting means;
causing said second radio transmission device to transmit the identification information being peculiar to said second radio transmission device and provided as said first control signal by said control means to said infrared signal transmitting means;
causing said second radio transmission device to convert the transmitted identification information peculiar to said second radio transmission device to a second infrared signal, and emitting said second infrared signal from said infrared signal transmitting means to said infrared signal receiving means of said first radio transmission device;
causing said first radio transmission device to receive said second infrared signal by said infrared signal receiving means;
obtaining the identification information peculiar to said second radio transmission device from said second infrared signal by said control means of said first radio transmission device;
receiving said first infrared signal by said infrared signal receiving means of said second radio transmission device; and
obtaining the identification information peculiar to said first radio transmission device from said first infrared signal by said control means of said second radio transmission device.

4. The mutual authentication method according to claim 3, wherein
said step of arranging said first and second radio transmission devices such that said infrared signal receiving means of one of said first and second radio transmission devices is adjacently opposed to said infrared signal transmitting means of the other includes a step of arranging said infrared signal receiving means of one of said first and second radio transmission devices in the opposed fashion within an irradiation range of an infrared emitting unit included in said infrared signal receiving means of the other.

5. A mutual authentication program of performing mutual authentication of opposite parties between first and second radio transmission devices performing radio transmission, each of said first and second radio transmission devices including:
control means for controlling said whole radio transmission device,
radio means for sending and receiving said data signal and a first control signal to be transmitted to and from the control means after converting the data signal and the fist control signal to radio signals,
infrared signal receiving means for receiving an infrared signal emitted from a remote control, converting the received infrared signal to an electric signal, extracting a second control signal from said electric signal, and transmitting said extracted second control signal to said control means,
infrared signal transmitting means for converting said second control signal transmitted from said control means to an infrared signal, and transmitting the converted infrared signal; and
signal path switching means arranged between said control means on one side, and said radio means and said infrared signal transmitting means on the other side for switching a transmission path of said first control signal, and
said program causing a computer to execute the steps of:
arranging the first and second radio transmission devices such that said infrared signal receiving means of one of said first and second radio transmission devices is adjacently opposed to said infrared signal transmitting means of the other;
forming, in each of said first and second radio transmission devices, a transmission path of said first control signal between said control means and said infrared signal transmitting means by said signal path switching means;
causing said first radio transmission device to transmit identification information provided as said first control signal by said control means and being peculiar to said first radio transmission device to said infrared signal transmitting means;
causing said first radio transmission device to convert the transmitted identification information peculiar to said first radio transmission device to a first infrared signal, and to emit said first infrared signal toward said infrared signal receiving means of said second radio transmission device from said infrared signal transmitting means;
causing said second radio transmission device to transmit the identification information being peculiar to said second radio transmission device and provided as said first control signal by said control means to said infrared signal transmitting means;
causing said second radio transmission device to convert the transmitted identification information peculiar to said second radio transmission device to a second infrared signal, and emitting said second infrared signal from said infrared signal transmitting means to said infrared signal receiving means of said first radio transmission device;
causing said first radio transmission device to receive said second infrared signal by said infrared signal receiving means;
obtaining the identification information peculiar to said second radio transmission device from said second infrared signal by said control means of said first radio transmission device;
receiving said first infrared signal by said infrared signal receiving means of said second radio transmission device; and
obtaining the identification information peculiar to said first radio transmission device from said first infrared signal by said control means of said second radio transmission device.

6. The mutual authentication program according to claim 5, wherein
said step of arranging said first and second radio transmission devices such that said infrared signal receiving means of one of said first and second radio transmission devices is adjacently opposed to said infrared signal transmitting means of the other includes a step of arranging said infrared signal receiving means of one of said first and second radio transmission devices in the opposed fashion within an irradiation range of an infrared emitting unit included in said infrared signal receiving means of the other.
